(19) United States
(12) Patent Application Publication
(10) Pub. No.: US 2012/0102037 A1
(43) Pub. Date: Apr. 26, 2012

(54) MESSAGE THREAD SEARCHING

(76) Inventor: Mehmet Kivanc Ozonat, San Jose, CA (US)

(21) Appl. No.: 12/912,236

(22) Filed: Oct. 26, 2010

(51) Int. Cl. G06F 17/30

(52) U.S. Cl. 707/738; 707/E17.089

(57) ABSTRACT

In one general aspect, a set of representations of message thread contents is decomposed into clusters of representations of message thread contents determined to be similar. Similarly, a set of representations of message thread titles is decomposed into clusters of representations of message thread titles determined to be similar, where the act of decomposing the set of representations of message thread titles is influenced by the act of decomposing the set of representations of message thread contents. In another general aspect, a search query is received and compared to representations of clusters of message threads (e.g., a cluster of representations of message thread titles). Based on this comparison, a particular cluster of message threads then is identified as matching the search query.

### BACKGROUND

On-line message forums enable users to post messages and other users to respond to such messages. Some businesses provide customer/product support in the form of on-line message forums. For example, a business may host an on-line message forum and encourage customers in need of customer/product support to post questions to the on-line message forum. Responses answering the questions then may be posted to the on-line message forum by other customers and/or by customer support representatives under the employ of the business. In addition to helping resolve the issue experienced by the customer who initially posted a question to the on-line message forum, the message thread that is generated responsive to the posting customer's initial message may serve as a resource for future customers who experience the same or a similar issue, thereby sparing such future customers from themselves having to post a question and wait for an appropriate response. On-line message forums hosted by businesses may grow to include many millions of message threads addressing many millions of different issues.

### BRIEF DESCRIPTION OF THE DRAWINGS

FIGS. 1, 2A, and 2B are illustrations of examples of user interfaces for interacting with an on-line message forum.

FIG. 3 is a schematic diagram of an example of a hierarchical cluster tree of data clusters.

FIG. 4 is a block diagram of an example of a communications system.

FIGS. 5-6 are flowcharts illustrating examples of processes for clustering message threads posted in an on-line message forum.

FIG. 7 is a flowchart illustrating an example of a process for searching message threads.

### DETAILED DESCRIPTION

Techniques are disclosed that enable searching of an on-line message forum (e.g., an on-line customer/product support forum) for relevant message threads. In order to enable searching of the message threads posted to an on-line message forum, a hierarchical, multi-view clustering of the message threads may be performed. A search query received from a user then may be matched to one of the clusters of message threads as the most relevant cluster to the search query. In the event that the searching user indicates a desire to view more search results, additional message threads may be presented to the searching user by presenting to the searching user the message threads from the next cluster up in the hierarchy.

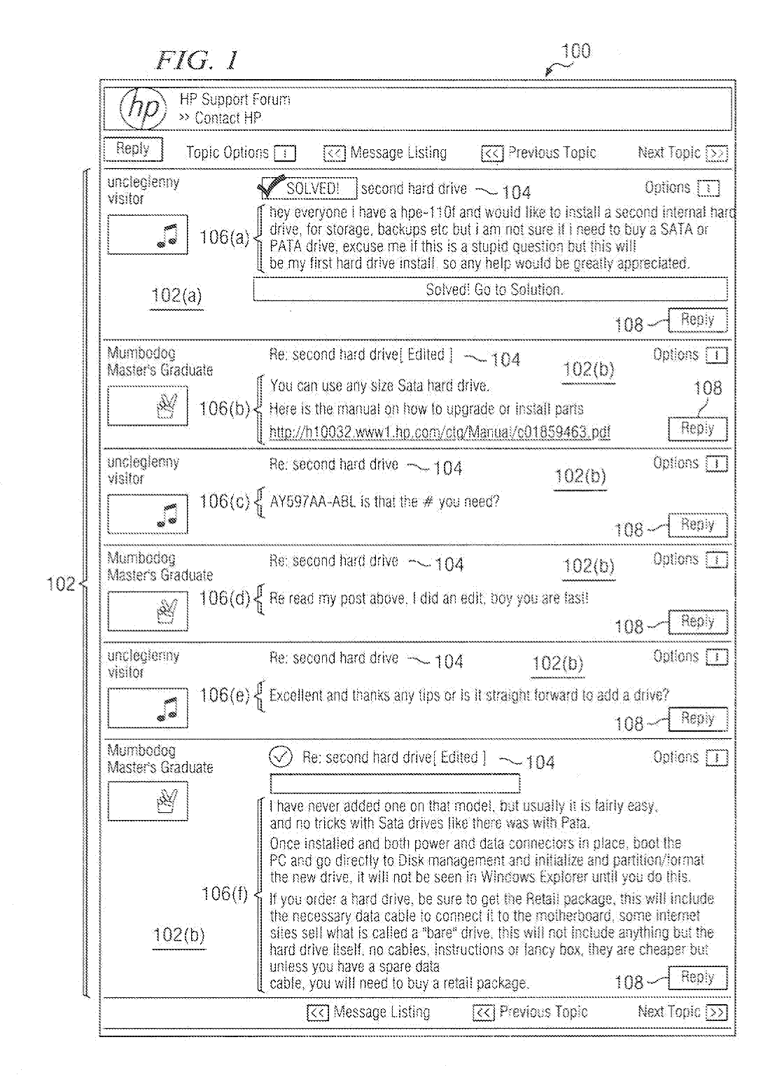

FIG. 1 is an illustration of an example of a user interface 100 for interacting with an on-line customer/product support message forum. The on-line message forum enables customers of a company to post messages to the on-line message forum detailing issues that they are experiencing with products or services from the company. Other users, including, for example, other customers and/or customer/product support specialists employed by the company, then may post responsive messages to the on-line message forum, thereby enabling the users to engage in a dialogue with the goal being to resolve the issue raised by the original message poster. The on-line message forum is configured to store original message postings and any responsive message postings as message threads that reflect the relationship(s) between the original message postings and their responsive message posting(s) and that, perhaps, preserve the chronological order of the postings as well.

The user interface 100 of FIG. 1 displays one example of a message thread 102 posted to the on-line message forum. Message thread 102 includes an original message 102(a) posted by a user (i.e., “uncleglenny”) seeking to resolve an issue related to the installation of a second hard drive in the user's personal computer. Original message 102(a) itself includes a title 104 (i.e., “second hard drive”) that was provided by the user who posted original message 102(a) (i.e., “uncleglenny”) and contents 106(a) that convey the substance communicated by original message 102(a). In addition to original message 102(a), message thread 102 includes a number of responsive messages 102(b) that are responsive to original message 102(a). As illustrated in FIG. 1, responsive messages 102(b) include titles 104, which are carried through for each of responsive messages 102(b) from original message 102(a), and contents 106(b)-106(f). Title 104 may be considered to be the title of message thread 102, and contents 106(a) of original message 102(a) and 106(b)-106(f) of responsive messages 102(b) collectively may be considered to be the contents of message thread 102.

Message thread 102, including original message 102(a) and responsive messages 102(b), reflects a dialogue between the poster of original message 102(a), “uncleglenny,” and another user, “Mumbodog,” as they attempt to resolve the issue related to the installation of the second hard drive. Although message thread 102 includes messages posted to the on-line message forum by only two different users, a message thread may include messages posted by any number of different users.

In order to reflect that original message 102(a) is the first message in message thread 102, user interface 100 displays original message 102(a) as the top message in message thread 102. Furthermore, in order to reflect that responsive messages 102(b) are responsive to original message 102(a), user interface 100 displays responsive messages 102(b) beneath original message 102(a) in message thread 102.

As illustrated in FIG. 1, user interface 100 provides selectable “Reply” controls 108 that are configured to enable a user to post a responsive message to any one of the messages 102(a) and 102(b) of message thread 102. Any new message posted as a response to any one of messages 102(a) and 102(b) of message thread 102 also may be considered to be a part of message thread 102. Generally speaking, a message and any messages that can be traced back to the message as being responsive to the message or any other message in the response chain collectively may be considered to form a message thread.

In addition to the message thread 102 displayed in user interface 100 of FIG. 1, the on-line message forum may include a number of other message threads as well. For example, the on-line message forum may include many hundreds, many thousands, many millions, etc. of message threads. Because these message threads tend to attempt to resolve issues experienced by customers, the message threads themselves may be good resources for other customers experiencing the same or similar issues to consult. However, due to the volume of message threads posted to the on-line message forum, it may be difficult for a customer to find the selection of message threads posted to the on-line message forum that are most relevant to the customer's issue. Therefore, in order to help a customer find message threads that are on point, the on-line message forum may provide a search capability that enables the customer to search for relevant message threads by entering a search query.

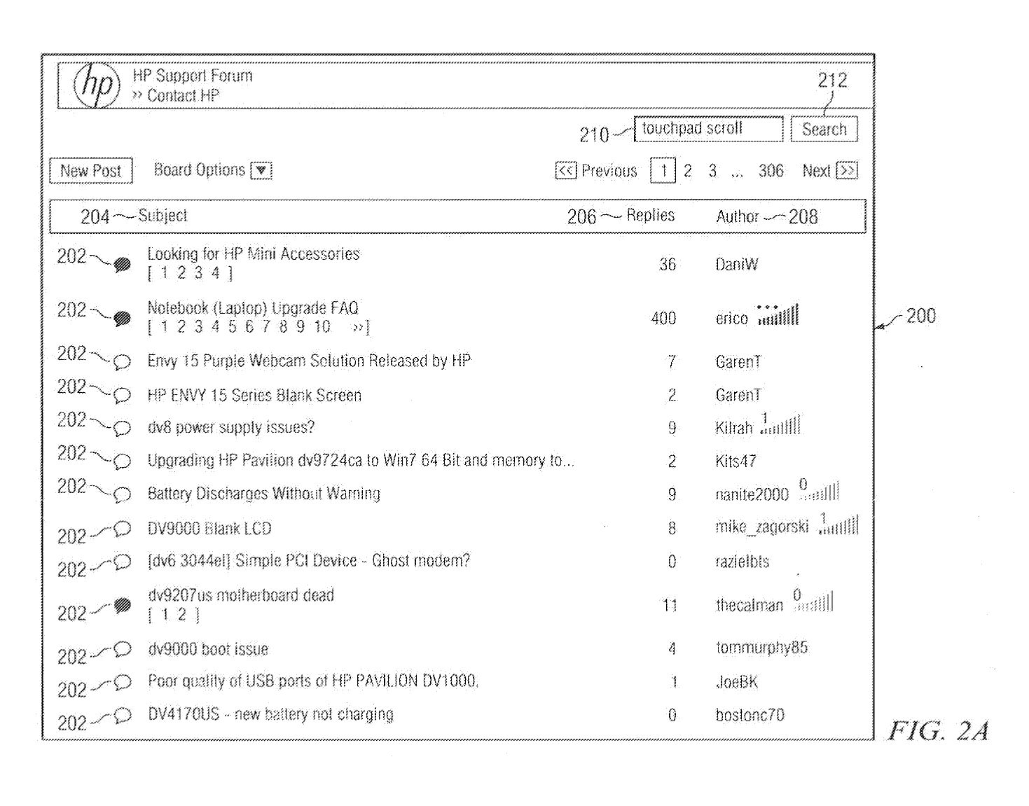

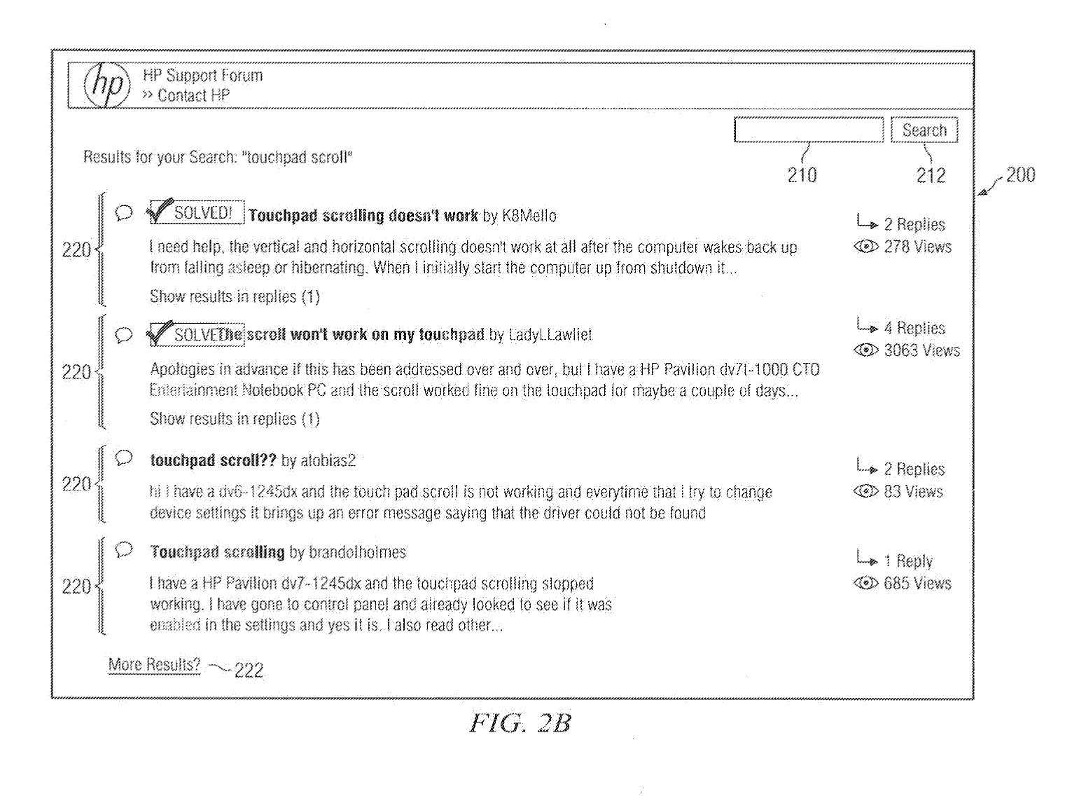

FIGS. 2A and 2B are illustrations of an example of a user interface 200 for interacting with an on-line message forum that provides a search capability. Referring first to FIG. 2A, user interface 200 displays a number of selectable references 202 to message threads that have been posted to the on-line message forum. As illustrated in FIG. 2A, each selectable reference 202 to a message thread includes an indication of the title 204 of the message thread, the number of responsive messages 206 that have been posted to the original message in the message thread, and the author 208 of the original message in the message thread. In order to access a particular one of the message threads 202 displayed by user interface 200, a user may select the particular message thread 202 and, in response, the on-line message forum may update user interface 200 to display one or more of the messages included within the particular message thread 202.

As can be seen from FIG. 2A, it may be difficult for a user to identify individual message threads 202 as being relevant to the user's interests based solely on the limited information (e.g., title 204, number of replies 206, and original author 208) displayed by user interface 200 for each message thread 202. Moreover, the sheer volume of the message threads posted to the on-line message forum may make it difficult for the user to browser and consider the relevance of each and every message thread that has been posted to the on-line message forum. Therefore, in order to help users identify relevant message threads, user interface 200 provides users with a search capability for searching for relevant message threads. In particular, user interface 200 includes a search query entry field 210 arid selectable “Search” control 212. In response to a user entering a search query into search query entry field 210 and, thereafter, selecting selectable “Search” control 212 within user interface 200, the on-line message forum may search for message threads posted to the on-line message forum that are relevant to the search query entered in search entry field 210. For example, as illustrated in FIG. 2A, a user has entered the search query “touchpad scroll” in search query entry field 210 (presumably because the reader is interested in browsing message threads related to touchpad scrolling issues).

Referring now to FIG. 2B, in response to user entry of the search query “touchpad scroll” in search query entry field 210 and subsequent selection of selectable “Search” control 212, the on-line message forum searches for message threads that have been posted to the on-line message forum that are related to the “touchpad scroll” search query and updates user interface 200 to display selectable references 220 to message threads that were determined, based on the results of the searching to be relevant to the “touchpad scroll” search query. The user then can access a particular one of the message threads by selecting the corresponding selectable reference 220 for the message thread. In the event that the user is interested in browsing more message threads than those initially returned by the on-line message forum in response to the “touchpad scroll” search query, the user can select selectable “More Results” control 222, in response to which the on-line message forum may return a broader and larger set of message threads.

In some implementations, the on-line message forum may search all message threads that have been posted to the on-line message forum in response to user entry of a search query via search entry field 210 and selectable “Search” control 212. Alternatively, in other implementations, the on-line message forum may search only a subset of less than all message threads posted to the on-line message forum in response to user entry of a search query via search entry field 210 and selectable “Search” control 212. Specific techniques for enabling searching of message threads posted to an on-line message forum are described in greater detail below.

In the context of searching an on-line customer/product support forum, there may be a one-to-one mapping between the goal of a search query and the set of message threads that are relevant to the query. For example, in an on-line customer/product support forum hosted by a computer manufacturer, there may be a one-to-one mapping between a search query attempting to resolve a personal computer (PC) overheating issue and a set of message threads directed to this topic. Similarly, there may be a one-to-one mapping between a search query attempting to resolve a PC virus issue and a set of message threads directed to this topic. Therefore, message thread clustering may be a particularly useful technique for enabling searching of on-line message forums in general, and on-line customer/product support forums in particular.

Additional utility may be achieved if the clustering algorithm used to cluster the message threads generates a hierarchical cluster tree in which the set of child nodes descending from any given parent node represent clusters of the constituent message threads of the parent node. This is because a hierarchical cluster tree structure inherently lends itself to a broadening of the results returned in response to any given search query. For example, when a hierarchical cluster tree of message threads is generated, a search of the message threads may be performed by comparing a search query to the lowest-level leaf nodes of the hierarchical cluster tree to determine the leaf node that most nearly matches the search query. If the searching user ultimately finds that the message threads of the leaf node determined to most closely match the search query do not satisfy the searching user's needs, additional broader (and related) results can be returned to the user for consideration by presenting the message threads of the next node up in the hierarchical cluster tree to the user.

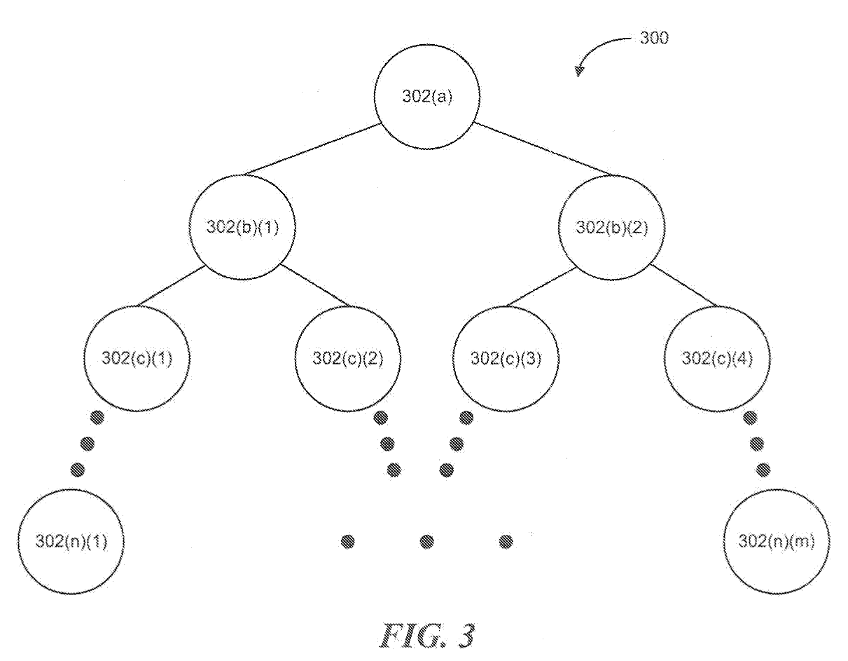

FIG. 3 is a schematic diagram of an example of a hierarchical cluster tree 300 of data clusters 302. Examination of the hierarchical cluster tree 300 illustrates the potential utility of using a clustering algorithm that generates a hierarchical cluster tree in order to cluster a collection of message threads posted to an on-line message forum. As illustrated in FIG. 3, the hierarchical cluster tree 300 includes a number of nodes 302. More particularly, the hierarchical cluster tree 300 includes a root node 302(a) having two child nodes 302(b)(1) and 302(b)(2), each of which also has two child nodes. For example, node 302(b)(1) has child nodes 302(c)(1) and 302(c)(2), and node 302(b)(2) has child nodes 302(c)(3) and 302(c)(4). Hierarchical cluster tree 300 includes a number of additional levels of nodes 302, the lowest level of which includes leaf nodes 302(n)(1)-302(n)(m). Although each parent node 302 of the hierarchical cluster tree 300 of FIG. 3 is illustrated as having exactly two child nodes, it will be appreciated that each parent node 302 of the hierarchical cluster tree 300 could have any number of two or more child nodes.

Each node 302 within hierarchical cluster tree 300 may be considered to be a cluster of related data samples with the child nodes 302 of any parent node 302 in the hierarchical cluster tree 300 representing clusters of related data samples, from the set of data included in the parent node 302. Thus, if root node 302(a) includes a set of data, the child nodes 302(b)(1) and 302(b)(2) of root node 302(a) represent clusters of related data from the set of data of node 302(a) that are generated by performing a clustering algorithm on the set of data of node 302(a) that assigns each data sample from the set of data of node 302(a) to one of nodes 302(b)(1) and 302(b)(2) based on the similarity between the data sample and the other data samples assigned to the same node. As such, the data samples assigned to node 302(a)(1) are presumed to be more closely related to one another than they are to the data samples assigned to node 302(a)(2) and vice versa. Similarly, at each level in the hierarchical cluster tree 300, the data sets of each node 302 are decomposed into more granular clusters of related data samples to form the next lower level of nodes 302 such that individually the nodes 302(n)(1)-302(n)(m) of the lowest level within the hierarchical cluster tree 300 individually represent the most granular clustering of data samples in the hierarchical cluster tree 300, while collectively the nodes 302(n)(1)-302(n)(m) of the lowest level within the hierarchical cluster tree 300 include all of the data samples of the set of data included in root node 302(a).

Thus, if the set of data included in root node 302(a) is a collection of message threads posted to an on-line message forum, the set of data included in each of leaf nodes 302(n)(1)-302(n)(m) represents a cluster of related message threads from the collection of message threads posted to the on-line message forum such that each of the message threads is assigned to one of leaf nodes 302(n)(1)-302(n)(m). The message threads posted to the on-line message forum then can be searched by comparing a search query to the message thread clusters of leaf nodes 302(n)(1)-302(n)(m) and identifying an individual one of leaf nodes 302(n)(1)-302(n)(m) as most nearly resembling the search query based on results of the comparison. The message threads belonging to the individual one of leaf nodes 302(n)(1)-302(n)(m) identified as most nearly resembling the search query then may be returned as the results of the search. In the event that these message threads belonging to the individual one of leaf nodes 302(n)(1)-302(n)(m) do not satisfy the goals of the user who initiated the search, a broader set of message threads may be returned as results of the search by returning all of the message threads included in the parent node of the individual one of leaf nodes 302(n)(1)-302(n)(m) identified as most nearly resembling the search query.

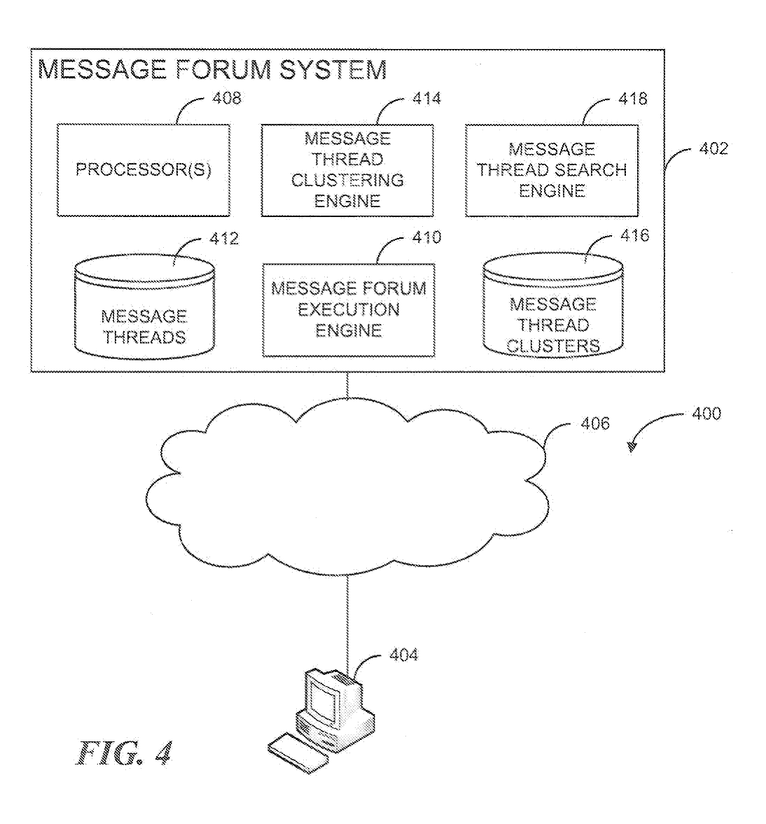

FIG. 4 is a block diagram of an example of a communications system 400, including a message forum system 402, a computer 404, and a network 406, that enables a user of computer 404 to post new messages to an on-line message forum and to browse and respond to messages previously posted to the on-line message forum. For illustrative purposes, several elements illustrated in FIG. A and described below are represented as monolithic entities. However, these elements each may include and/or be implemented on numerous interconnected computing devices and other components that are designed to perform a set of specified operations and that are located proximally to one another or that are geographically displaced from one another.

As illustrated in FIG. 4, the message forum system 402 is accessible to computer 404 over network 406.

Message forum system 402 may be implemented using one or more computing devices (e.g., servers) configured to provide a service to one or more client devices (e.g., computer 404) connected to message forum system 402 over network 406. The one or more computing devices on which message forum system 402 is implemented may have internal or external storage components storing data and programs such as an operating system and one or more application programs. The one or more application programs may be implemented as instructions that are stored in the storage components and that, when executed, cause the one or more computing devices to provide the features of the message forum system 402 described herein.

Furthermore, the one or more computing devices on which message forum system 402 is implemented each may include one or more processors 408 for executing instructions stored in storage and/or received from one or more other electronic devices, for example over network 406. In addition, these computing devices also typically include network interfaces and communication devices for sending and receiving data.

Computer 404 may be any of a number of different types of computing devices including, for example, a personal computer, a special purpose computer, a general purpose computer, a combination of a special purpose and a general purpose computer, a laptop computer, a tablet computer, a netbook computer, a smart phone, a mobile phone, a personal digital assistant, and a portable media player. Computer 404 typically has internal or external storage components for storing data and programs such as an operating system and one or more application programs. Examples of application programs include client applications (e.g., e-mail clients) capable of communicating with other computer users, accessing various computer resources, and viewing, creating, or otherwise manipulating electronic content and browser applications capable of rendering Internet content and, in some cases, also capable of supporting a web-based e-mail client. In addition, the internal or external storage components for computer 404 may store a dedicated client application for interfacing with message forum system 402. Alternatively, in some implementations, computer 404 may interface with message forum system 402 without a specific client application (e.g., using a web browser).

Computer 404 also typically includes a central processing unit (CPU) for executing instructions stored in storage and/or received from one or more other electronic devices, for example over network 406. In addition, computer 404 also usually includes one or more communication devices for sending and receiving data. One example of such a communications device is a modem. Other examples include an antenna, a transceiver, a communications card, and other types of network adapters capable of transmitting and receiving data over network 406 through a wired or wireless data pathway.

Network 406 may provide direct or indirect communication links between message forum system 402 and computer 404 irrespective of physical separation between the two. As such, message forum system 402 and computer 404 may be located in close geographic proximity to one another or, alternatively, message forum system 402 and computer 404 may be separated by vast geographic distances. Examples of network 406 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data.

As illustrated in FIG. 4, message forum system 402 includes a message forum execution engine 410 for providing an on-line message forum such as one of the on-line message forums described herein that enable users to post messages and browse and respond to previously-posted messages. Message forum execution engine 410 may be implemented as instructions stored in a computer memory storage system that, when executed, cause processor(s) 408 to provide the functionality ascribed herein to message forum execution engine 410.

Message forum system 402 also includes a computer memory storage system 412 for storing message threads posted to the on-line message forum. Message forum system 402 is configured to store original message postings to the on-line message forum and responsive message postings to the on-line message forum within computer memory storage system 412 in a manner that reflects the relationship between original message postings to the on-line message forum and responsive message postings to the on-line message forum and, perhaps, preserve the chronological order of the postings as well.

In addition, message forum system 402 includes a message thread clustering engine 414 for decomposing the collection of message threads posted to the on-line message forum and stored within computer memory storage system 412 into clusters of related message threads. Message thread clustering engine 414 may be implemented as instructions stored in a computer memory storage system that, when executed, cause processor(s) 408 to perform clustering techniques such as the clustering techniques described herein in order to decompose the collection of message threads posted to the on-line message forum and stored within computer memory storage system 412 into clusters of related message threads.

Message forum system 402 also includes a computer memory storage system 416 for storing message thread clusters generated by message thread clustering engine 414. As such, after message thread clustering engine 414 decomposes a collection of message threads posted to the on-line message forum into clusters of related message threads, the message thread clusters and/or information about the clustering of the message threads may be stored in computer memory storage system 416.

Furthermore, message forum system 402 includes a message thread search engine 418 for searching for message threads posted to the on-line message forum and stored within computer memory storage system 412 that are relevant to a search query. For example, responsive to receiving a search query, message thread search engine 418 may compare the received search query to clusters of related message threads generated by message thread clustering engine 414 and stored in computer memory storage system 416 to identify a particular one of the message thread clusters perceived as most closely matching the received search query. After identifying the individual cluster of message threads perceived as most closely matching the received search query, the message thread search engine 418 may return the message threads belonging to the identified message thread cluster as the results of the search. Message thread search engine 418 may be implemented as instructions stored in a computer memory storage system that, when executed, cause processor(s) 408 to perform message thread searching techniques such as the message thread searching techniques described herein in order to identify message threads posted to the on-line message forum and stored within computer memory, storage system 412 that are relevant to a search query.

Message forum system 402 may be accessible to computer 404 via network 406. Consequently, a user of computer 404 may be able to post new messages to the on-line message forum provided by message forum system 402 using computer 404. In response to receiving such new messages from a user of computer 404, message forum system 402 may store the new messages in computer memory storage system 412 so that they are accessible to other users of the on-line message forum. In addition to posting new messages to the on-line message forum, a user of computer 404 also may be able to browse and respond to message threads that have been posted to the on-line message forum previously. As with new messages that a user of computer 404 posts to the on-line message forum, message forum system 402 may store responsive messages posted by a user of computer 404 in computer memory storage system 412 so that they are accessible to other users of the on-line message forum. In addition, message forum system 402 may store such responsive messages in a manner that reflects their relationship to the messages to which they are responsive and the message threads to which they belong.

Beyond enabling posting new messages and browsing and responding to previously posted message threads, message forum system 402 also enables a user of computer 404 to access message, forum system 402 via network 406 and search for relevant message threads posted to the on-line message forum. For example, a user of computer 404 may use computer 404 to submit a search query to the message thread search engine 418 of message forum system 402. In response to receiving such a search query, message thread search engine 418 may compare the search query to the message thread dusters stored in computer memory storage system 416 and identify one (or more) of the message thread clusters stored in computer memory storage system 416 as being relevant to the search query. Thereafter, message thread search engine 418 may return indications of the message threads belonging to the identified message thread clusters to computer 404 over network 406.

In order to facilitate searching of a collection of message threads posted to an on-line, message forum, the message threads posted to the on-line message forum may be represented as feature vectors. In some implementations, the feature vectors may be n-dimensional feature vectors, where n represents some predefined subset of the words included within the collection of message threads posted to the on-line message forum (e.g., excluding so-called “stop words” like articles, prepositions, and other commonly-used, non-descriptive words), that track the presence and/or frequency of each of the n words within the individual message threads. For example, the feature vectors may be n-dimensional vectors where each element corresponds to an individual one of the n words such that, within the feature vector for any one of the message threads, the element corresponding to a particular one of the n words may be set to 1 (e.g., true) if the particular word appears in the message thread, whereas the element corresponding to the particular word may be set to 0 (e.g., false) if the particular word does not appear in the message thread in order to track the presence of words within the message threads. Similarly, in order to track the frequency of words within the message threads, the feature vectors may be n-dimensional vectors where each element corresponds to an individual one of the n words such that, within the feature vector for any one of the message threads, the element corresponding to a particular one of the n words may be set to the number of times the particular word appears in the message thread. In other implementations, the feature vectors may be n-dimensional feature vectors, where n represents all of the words included within the collection of message threads posted to the on-line message forum, that track the presence and/or frequency of each of the n words within the individual message threads.

The titles of message threads (often including just a few words) posted to an on-line message forum may have different characteristics than their corresponding contents (often including multiple sentences). As a result, it may be challenging to combine a message thread title and the message thread's corresponding contents into a single feature vector. Therefore, two feature vectors may be generated for each message thread: one for the message thread's title and another for the message thread's contents. Then, in order to generate a hierarchical clustering of the message threads posted to the on-line message forum, a multi-view approach may be employed in which a first hierarchical cluster tree is generated based on the feature vectors for the message thread titles and a second hierarchical cluster tree is generated based on the feature vectors for the message thread contents, where the clustering of the message threads based on their titles influences the clustering of the message threads based oh their contents and vice versa.

As will be discussed in greater detail below, Gaussian mixture models may be used to design clusters of message threads posted to an on-line message forum. Although the expectation-maximization (EM) algorithm often may be employed when using Gaussian mixture models to design clusters, the EM algorithm assumes that the underlying data follows a Gaussian mixture distribution and that, therefore, each data sample belongs to each cluster with some membership probability. Consequently, the update step of the EM algorithm may pose an intractable problem in a hierarchical, multi-view setting. To address this issue, Gauss mixture vector quantization (GMVQ), which assumes that each data sample belongs to only one cluster, may be used to generate the message thread clusters instead of the EM algorithm. Furthermore, to accommodate the multi-view approach to message thread clustering, GMVQ may be extended to the multi-view setting, enabling the design of two hierarchical cluster trees: one for message thread titles and the other for message thread contents.

As discussed above, each message thread posted to the on-line message forum may be converted into two representative feature vectors: one corresponding to the message thread title and a second corresponding to the contents of the message thread. Generalizing, the i^{th} thread within the message threads posted to the on-line message forum, 1≦i≦N, may be represented by a pair of feature vectors, x_{i, 1}, the feature vector corresponding to the thread title, and x_{i, 2}, the feature vector corresponding to the thread content, where N is the cardinality of the training set. Similarly, the set of title feature vectors for the message threads posted to the on-line message forum may be denoted by X₁={x_{1, 1}, x_{2, 1}, . . . , x_{N, 1}}, and the set of contents feature vectors for the message threads posted to the on-line message forum is denoted by X₂={x_{1, 2}, x_{2, 2}, . . . , x_{N, 2}}.

Multi-view, hierarchical clustering functions then may be performed on X₁ and X₂ such that each clustering function operates under the influence of the other with the goal being to minimize the disagreement between the two resultant hierarchical cluster trees. That is to say, denoting the clustering functions of X₁ and X₂ by α₁(X₂) and α₂(X₂), respectively, the goal is to find the pair of functions α₁ and α₂ that minimizes:

P(α₁(X₁)≠α₂(X₂)), (Eq. 1)

where P is an empirical probability.

Overfitting occurs when X₁ and X₂ are decomposed into too many clusters to be useful when Equation (1) is minimized. For example, if 1000 message threads are posted to an on-line message board, there is no value in performing a clustering algorithm on the message threads if the end result of the clustering algorithm is that the 1000 message threads are clustered into 1000 corresponding single-thread clusters. Therefore, in order to reduce, the effects of overfitting, constraints on the entropy of the clusters may be imposed when Equation (1) is minimized. The more granularly X₁ and X₂ are decomposed into clusters, the greater the entropy of the clusters. Consequently, imposing a constraint on the entropy of the clusters may serve to prevent X₁ and X₂ from being decomposed too granularly.

The problem of minimizing Equation (1) when constraints are imposed on the entropy of the clusters can be viewed as a Lagrangian problem with the cost function:

P(α₁(X₁)≠α₂(X₂))+λᵥRᵥ, v=1, 2 (Eq. 2)

where R₁ is a constraint on the entropy of clusters of α₁, R₂ is a constraint on the entropy of clusters of α₂, and λ₁ and λ₂ are the Lagrangian parameters. Rᵥ, v=1, 2 may be expressed as:

Rᵥ=−Σᵢ₌₁^{K}^{ᵥ}P(αᵥ(Xᵢ))log P(αᵥ(Xᵢ)), v=1, 2, (Eq. 3)

where the probabilities are empirical and Kᵥ is the number of clusters for αᵥ.

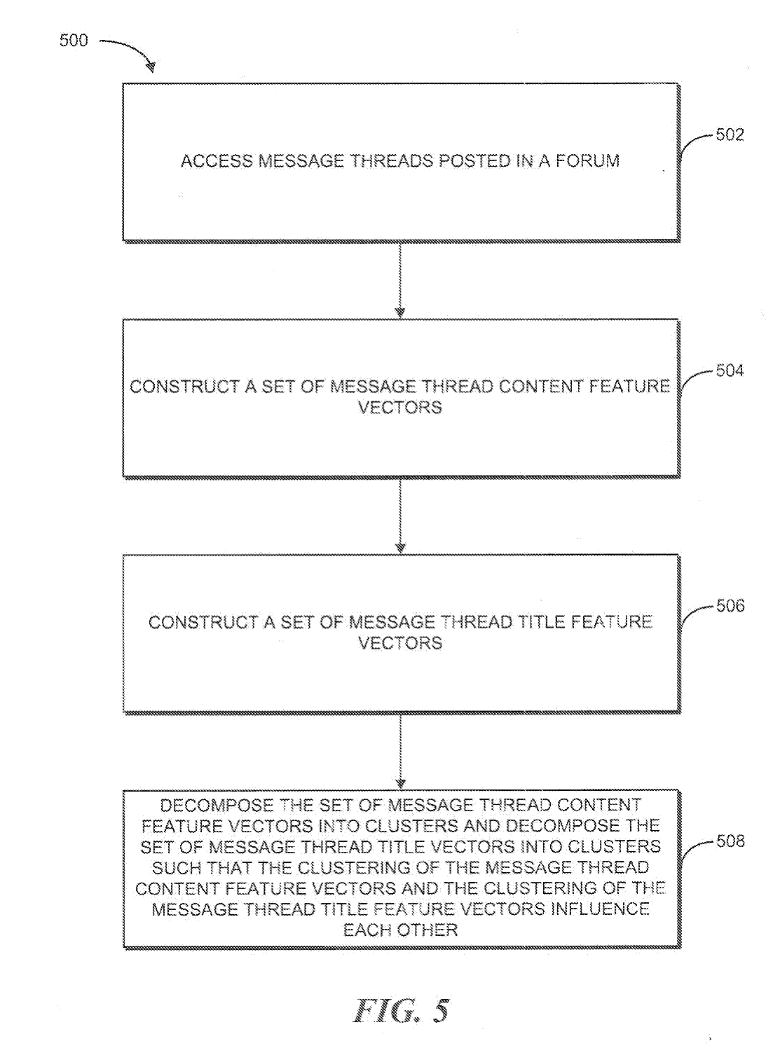

FIG. 5 is a flowchart 500 illustrating an example of a process for clustering message threads posted in an on-line message forum. The process illustrated in the flowchart 500 of FIG. 5 may be performed by a message forum system such as the message forum system 402 illustrated in FIG. 4. More specifically, the process illustrated in the flowchart 500 of FIG. 5 may be performed by processor(s) 408 of the computing devices that implement the message forum system 402 under the control of message thread clustering engine 414.

Initially, message threads posted in the forum are accessed (502). Then, a set of message thread content feature vectors is constructed (504), and a set of message thread title feature vectors is constructed (506). Thereafter, the set of message thread content feature vectors are decomposed into a first set of clusters of related message threads, and the set of message thread title feature vectors are decomposed into a second set of clusters of related message threads such that the clustering of the message thread content feature, vectors and the cluster of the message thread title feature vectors influence each other (508). For example, the set of message thread content feature vectors and the set of message thread title feature vectors may be decomposed into clusters by minimizing Equation (2).

Having discussed the general principle of designing a multi-view, hierarchical clustering algorithm for clustering message threads posted to an on-line message forum, the design of one specific example of such an algorithm is described below.

First, the concept of GMVQ is introduced. Consider two (not necessarily Gaussian) mixture distributions f and g:

f(Z)=Σₖpₖfₖ(Z), (Eq. 4)

and

g(Z)=Σₖpₖgₖ(Z), (Eq. 5)

where pₖ represents the probability of mixture component k, fₖ(Z) is the probability distribution function of mixture component k, and gₖ(Z) is a Gaussian model of the probability distribution of mixture component k.

Defining the distance, D, between f and g as a weighted (by pₖ) sum of the Kullback-Leibler distances between the mixture components fₖ and gₖ, D is given by:

D(f, g)=ΣₖpₖI(fₖ∥gₖ), (Eq. 6)

where I(fₖ∥gₖ) denotes the Kullback-Leibler distance between fₖ and gₖ.

Now, consider a set of message thread feature vectors (e.g., a set of message thread title feature vectors or a set of message thread content feature vectors) {z_{i, 1}≦i≦N} with its (not necessarily Gaussian) underlying distribution f in the form f(Z)=Σₖpₖfₖ(Z). In order to cluster the message threads, the goal of GMVQ is to find the Gaussian mixture distribution g that minimizes (e.g., in the Lloyd-optimal sense) Equation (6), which can be accomplished iteratively by performing the following two updates at each iteration:
(i) Given μₖ, Σₖ, and pₖ for each cluster k, assign each message thread feature vector zᵢ to the cluster k that minimizes:

$$\frac{1}{2} log ( \vert {\sum }_{k} \vert ) + \frac{1}{2} {( {z}_{i} - {μ}_{k} )}^{T} {\sum }_{k}^{- 1} ( {z}_{i} - {μ}_{k} ) - log {p}_{k} , \qquad ( Eq . 7 )$$

where |Σₖ| is the determinant of Σₖ. (Note that Equation 7 may also be known as the QDA distortion.)
(ii) Given the cluster assignments, set μₖ, Σₖ, and pₖ as:

$$\begin{matrix}{μ}_{k} = \frac{1}{‖ {s}_{k} ‖} {\sum }_{{z}_{i} ∈ {s}_{k}} {z}_{i} , & ( Eq . 8 ) \\ {\sum }_{k} = \frac{1}{‖ {s}_{k} ‖} {\sum }_{i} ( {z}_{i} - {μ}_{k} ) {( {z}_{i} - {μ}_{k} )}^{T} , \\ and & ( Eq . 9 ) \\ {p}_{k} = \frac{‖ {s}_{k} ‖}{N} , & ( Eq . 10 )\end{matrix}$$

where Sₖ is the set of message thread feature vectors zᵢ assigned to the cluster k, and ∥Sₖ∥ is the cardinality of the set.

A hierarchical cluster tree for the set of message thread feature vectors can be grown by iteratively applying GMVQ to the set of message thread feature vectors. At each iteration, an existing leaf node of the tree is decomposed into two (or more) child nodes (i.e., clusters) of message thread feature vectors by assigning each of the message thread feature vectors of the node to one of the child nodes through application of the Lloyd updates of Equations (8)-(10) and minimization of Equation (7). For example, at the first iteration, the entire set of message thread feature vectors is decomposed into two (or more) child nodes of message thread feature vectors by assigning each of the message thread feature vectors to one of the child nodes. In order to continue to grow the hierarchical cluster tree, this procedure of growing two (or more) child nodes out of an existing node can be repeated.

As discussed above, clustering any set of data may be of little value if the result of the clustering is too granular. Therefore, a clustering algorithm may impose a constraint on the entropy of the clusters in order to reduce the effects of overfitting.

When GMVQ is employed to grow a hierarchical cluster tree by decomposing existing nodes, into two (or more) child nodes, the effects of overfitting may be reduced by incorporating the Breiman, Friedman, Olshen, and Stone (BFOS) algorithm into the tree growing process to enable both growing and pruning of the hierarchical cluster tree to achieve a desired balance between the fit of the message thread feature vectors to the clusters and the entropy of the clusters. According to the BFOS algorithm, each node of a tree is to have two linear functionals, one of which is monotonically increasing and the other of which is monotonically decreasing. Toward this end, we view the QDA distortion (i.e., Equation (7)) of any sub-tree, T, of a tree as a sum of two functionals, u₁ and u₂, such that:

$$\begin{matrix}{u}_{1} ( T ) = \frac{1}{2} {\sum }_{k ∈ T} {l}_{k} log ( \vert {\sum }_{k} \vert ) + \frac{1}{N} {\sum }_{k ∈ T} {\sum }_{{z}_{i} ∈ {s}_{k}} \frac{1}{2} {( {z}_{i} - {u}_{k} )}^{T} {\sum }_{k}^{- 1} ( {z}_{i} - {μ}_{k} ) , \\ and & ( Eq . 11 ) \\ {u}_{2} ( T ) = - {\sum }_{k ∈ T} {p}_{k} log {p}_{k} & ( Eq . 12 )\end{matrix}$$

where kεT denotes the set of clusters (i.e., tree leaves) of the sub-tree T, and μₖ, Σk, pₖ and the set Sₖ are as defined above in connection with Equations (7)-(10). The functionals u₁ and u₂ in Equations (11) and (12) are linear as each can be represented as a linear sum of its components in each terminal node of the sub-tree. Moreover, the functional u₁ is monotonically increasing, while the functional u₂ is monotonically decreasing. More particularly, the functional u₁ is monotonically increasing because it represents the fit of the message thread feature vectors to the clusters, and the message thread feature vectors fit the clusters better the more granularly they are clustered (i.e., the more clusters there are, the better the. message thread feature vectors fit the clusters). Meanwhile, that the functional u₂ is monotonically decreasing follows from Jensen's inequality and convexity, and because the functional u₂ represents the entropy of the clusters which decreases with fewer clusters.

Thus, as with Equation (7), Equation (11) can be used to decompose an existing leaf node of a hierarchical cluster tree into two (or more) child nodes (i.e., clusters) of message thread vectors. Specifically, an existing leaf node of the tree can be decomposed into two (or more) child nodes (i.e., clusters) of message thread feature vectors by assigning each of the message thread feature vectors of the node to one of the child nodes through application of the Lloyd updates of Equations (8)-(10) and minimization of Equation (11).

As discussed above, incorporation of the BROS algorithm info the hierarchical cluster tree design also enables pruning of a tree to strike a balance between the fit of the message thread feature vectors to the clusters and the entropy of the clusters. By the linearity and monotonicity of the functionals u₁ and u₂, the optimal sub-trees (to be pruned) are nested, and, at each pruning iteration, the selected sub-tree is the one that minimizes:

$$r = - \frac{Δ {u}_{1}}{Δ {u}_{2}} \qquad ( Eq . 13 )$$

where Δuᵢ, i=1, 2, is the change of the functional uᵢfrom the current sub-tree to the pruned sub-tree of the current sub-tree. The magnitude of Equation (13) increases at each iteration, and pruning is terminated when the magnitude of Equation (13) reaches λ, resulting in the sub-tree that minimizes u₁+λᵤ₂.

To this point, the discussion of designing a hierarchical cluster tree has focused on designing a single tree. However, as discussed above, a multi-view approach to clustering may be employed to design two hierarchical cluster trees of message thread feature vectors: one using the message thread title feature vectors, X_{i, 1}, and the other using the message thread content feature vectors, X_{i, 2}. As with the approach for designing a single hierarchical cluster tree described above, the multi-view approach to designing the hierarchical cluster trees involves iteratively growing and pruning the hierarchical cluster trees. In contrast to designing a single hierarchical cluster tree, however, the multi-view approach to designing two hierarchical cluster trees involves, at each iteration, growing and pruning both of the hierarchical cluster trees jointly to minimize Equation (2), which, as discussed above, represents the probability that the two hierarchical cluster trees disagree with constraints imposed on the cluster entropy.

More particularly, at each iteration, the tree growing starts with a single leaf node for each of the two hierarchical cluster trees out of which a sub-tree of two (or more) child nodes are grown by applying the Lloyd updates of Equations (8)-(10) and minimizing Equation (11) (or Equation (7)) to assign each message thread feature vector to one of the two (or more) child nodes. Then, another leaf node from each of the two hierarchical cluster trees is selected to be decomposed into two (or more) new child nodes. In some cases, the leaf node to be decomposed from each of the two hierarchical cluster trees is selected from among the existing leaf nodes of the hierarchical cluster tree by identifying the leaf node that, when decomposed, will have the greatest impact, among ail of the existing leaf nodes, on reducing Equation (2). This procedure of growing two (or more) child nodes out of one of the existing nodes of each of the two hierarchical cluster trees may be repeated to continue to grow the two hierarchical cluster trees.

Turning now to the specifics of designing the two hierarchical cluster trees, the hierarchical cluster tree for clustering the message thread title feature vectors is denoted by T₁ and the hierarchical cluster tree for clustering the message thread content feature vectors is denoted by T₂. The trees T₁ and T₂ then are designed using the BFOS algorithm to minimize Equation (2). This implies that, at iteration m, the sub-tree functionals for T₁ are:

u₁^{m}(T)=Σ_{kεT}_{₁}_{^{m}}Σₓ_{ᵢ}_{εS}_{ₖ}P(α₁^{m}(x_{i, 1})≠α₂^{m-1}(x_{i, 2})), (Eq. 14)

u₂^{m}(T)=−Σ_{kεT}_{₁}_{^{m}}pₖ log pₖ. (Eq. 15)

The u₁ and u₂ functionals for T₂ are analogous:

u₁^{m}(T)=Σ_{kεT}_{₂}_{^{m}}Σₓ_{ᵢ}_{εS}_{ₖ}P(α₁^{m}(x_{i, 1})≠α₂^{m}(x_{i, 2})), (Eq. 16)

u₂^{m}(T)=−Σ_{kεT}_{₂}_{^{m}}pₖ log pₖ (Eq. 17)

Comparing Equation (3) with Equations (15) and (17) leads to the observation that:

Σ_{T}_{₁}u₂^{m}(T)=R₁, and (Eq. 18)

Σ_{T}_{₂}u₂^{m}(T)=R₂. (Eq. 19)

Similarly, comparing Equation (1) with Equations (14) and (16) leads to the observation that:

Σ_{T}_{₁}u₁^{m}(T)=P(α₁^{m}(X₁)≠α₂^{m-1}(X₂)), and (Eq. 20)

Σ_{T}_{₂}u₁^{m}(T)=P(α₂^{m}(X₂)≠α₁^{m}(X₁)). (Eq. 21)

The u₂^{m} functionals in Equations 15 and 17 are identical to the u₂ functional in Equation (12). As for the u₁^{m} functional, the hierarchical cluster trees may be grown by applying the Lloyd updates of Equations (8)-(10) and minimizing Equation (11) for each of the two hierarchical cluster trees. However, for the pruning of the two hierarchical cluster trees, the functionals of Equations (14) and (16), respectively, may be used instead of the functional of Equation (11). This is possible since Equations (14) and (16), like Equation (11), also are linear and monotonically decreasing functionals.

The above-described iterative process for designing the two hierarchical cluster trees can be summarized as follows:
(i) Grow the hierarchical cluster tree T₁ for the set of message thread title feature vectors X_{i, 1}, using the functionals u₁ and u₂ as given in Equations (11) and (12), respectively.
(ii) Grow the hierarchical cluster tree T₂ for the set of message thread contents feature vectors X_{i, 2}, using the functionals u₁ and u₂ as given in Equations (11) and (12), respectively.
(iii) Given the tree T₂, prune the tree T₁ using the BFOS algorithm with the functionals u₁ and u₂ as given in Equations (14) and (12), respectively.
(iv) Given the tree T₁, prune the tree T₂ using the BFOS algorithm with the functionals u₁ and u₂ as given in Equations (16) and (12), respectively.
(v) Repeat the process beginning with (i) unless the change in the cost function given in Equation (2) from the previous iteration is less than a predefined threshold value. (In some implementations, the predefined threshold value is set such that the process terminates if the change in the cost function of Equation (2) is less than 1 percent from one iteration to the next.)

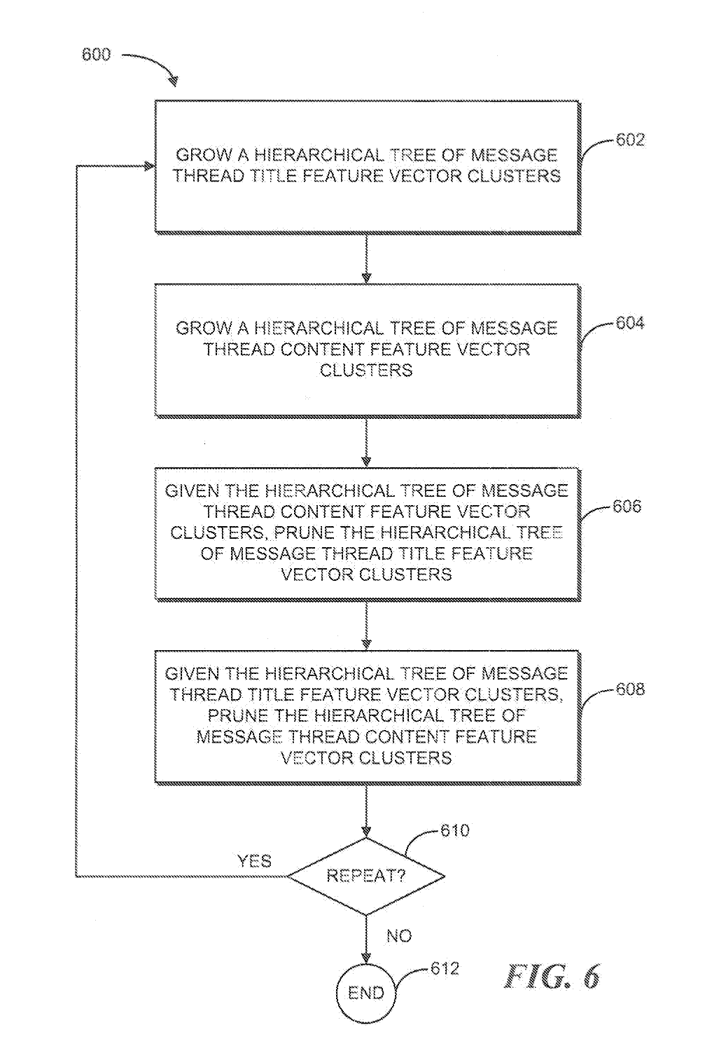

FIG. 6 is a flowchart 600 illustrating an example of a process for clustering message threads posted in an on-line message forum. The process illustrated in the flowchart 600 of FIG. 6 may be performed by a message forum system such as the message forum system 402 illustrated in FIG. 4. More specifically, the process illustrated in the flowchart 600 of FIG. 6 may be performed by processor(s) 408 of the computing devices that implement the message forum system 402 under the control of message thread clustering engine 414.

As illustrated in FIG. 6, a hierarchical tree of message thread title feature vector clusters is grown (602). For example, the hierarchical tree of message thread title feature vector clusters may be grown using the functionals u₁ and u₂ as given in Equations (11) and (12), respectively. In addition, a hierarchical tree of message thread content feature vector clusters is grown (604). For example, the hierarchical tree of message thread content feature vector clusters may be grown using the functionals u₁ and u₂ as given in Equations (11) and (12), respectively.

Given the hierarchical tree of message thread content feature vector clusters, the hierarchical tree of message thread title feature vector clusters then is pruned (606). For example, the BFOS algorithm may be used to prune the hierarchical tree of message thread title feature vectors with the functionals u₁ and u₂ as given in Equations (14) and (12), respectively. In addition, given the hierarchical tree of message thread title feature vector dusters, the hierarchical tree of message thread content feature vector dusters also is pruned (608). For example, the BFOS algorithm may be used to prune the hierarchical tree of message thread title feature vectors With the functionals u₁ and u₂ as given in Equations (16) and (12), respectively.

After the hierarchical tree of message thread title feature vectors and the hierarchical tree of message thread content feature vectors have been pruned, a decision is made as to whether or not another iteration of the clustering process should be performed (610). For example, the clustering process may be repeated unless the change in the cost function given in Equation (2) from the previous iteration is less than a predefined threshold value. If a decision is made to perform another iteration of the clustering process, the process returns to 602 and repeats, Otherwise, the process ends (612).

After a collection of message threads has been decomposed into clusters of related message threads, the collection of message threads may be searched by comparing a search query to the message thread clusters to identify one or more message thread clusters that are relevant to the search query. Message thread titles generally may be structured similarly to search queries (e.g., both may be only a few words long), while the contents of message threads may be structured differently than search queries (e.g., search queries may be only a few words long while the contents of message threads may be several sentences long). Therefore, in implementations where a first clustering of the message threads posted to an on-line message forum is constructed based on the message thread titles and a second clustering of message threads is constructed based oh the message thread contents, search queries may be compared to the message thread title clusters.

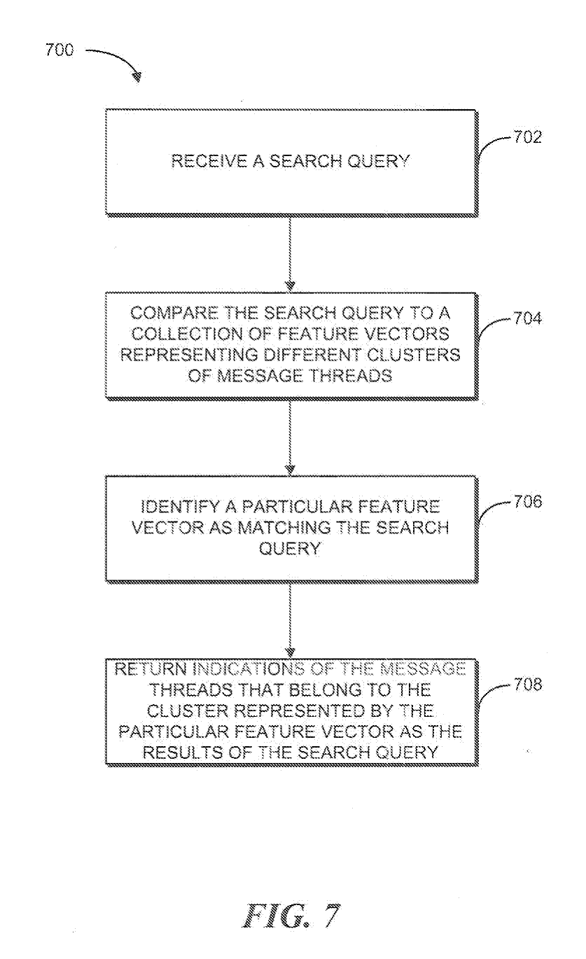

FIG. 7 is a flowchart 700 illustrating an example of a process for searching message threads. The process illustrated in the flowchart 700 of FIG. 7 may be performed by a message forum system such as the message forum system 402 illustrated in FIG. 4. More specifically, the process illustrated in the flowchart 700 of FIG. 7 may be performed by processor(s) 408 of the computing devices that implement the message forum system 402 under the control of message thread search engine 418.

Initially, a search query is received (702). The search query then is compared to a collection of feature vectors representing different clusters of message threads (704). For example, the search query may be converted into a feature vector and compared to composite feature vectors constructed for each of the different clusters of related message thread titles. Thereafter, based on tie results of comparing the search query to the collection of feature vectors representing the different clusters of message threads, a particular one of the feature vectors representing the different clusters of related message thread titles is identified as matching the search query (706). For example, the feature vector that is the most similar to a feature vector constructed for the search query may be identified as the feature vector that matches the search query.

After a feature vector has been identified as matching the search query, indications of the message threads that belong to the cluster represented by the particular feature vector are returned as results of the search query (708).

A number of methods, techniques, systems, and apparatuses have been described. However, variations are possible. For example, while the techniques for clustering and searching message threads described herein generally are described in the context of message threads posted to an on-line message forum, these clustering and searching techniques may be employed to search for relevant message threads in any context in which messages are arranged in threads. For instance, these techniques may be employed to cluster and search for e-mail threads and/or web log (blog) threads.

The described methods, techniques, systems, and apparatuses may be implemented in digital electronic circuitry or computer hardware, for example, by executing instructions stored in computer-readable storage media.

Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order, in some implementations, individual operations may be rearranged in a different order and/or eliminated and the desired results still may be achieved. Similarly, components in the disclosed systems may be combined in a different manner and/or replaced or supplemented by other components and the desired results still may be achieved.

What is claimed is:

1. A computer-implemented method comprising:
accessing, from a computer memory storage system, a collection of message threads posted to a forum, each individual message thread including a title and content that is distinct from the title;
constructing a set of representations of the contents of the accessed collection of message threads;
constructing a set of representations of the titles of the accessed collection of message threads;
decomposing the set of representations of message thread contents, into clusters of representations of message thread contents determined to be similar; and
decomposing the set of representations of message thread titles into clusters of representations of message thread titles determined to be similar, the decomposing of the set of representations of message thread titles into clusters of representations of message thread titles determined to be similar being influenced by the decomposing of the set of representations of message thread contents into clusters of representations of message thread contents determined to be similar.

2. The method of claim 1 wherein the decomposing the set of representations of message thread contents into clusters of representations of message thread contents determined to be similar is influenced by the decomposing the set of representations of message thread titles into clusters of representations of message thread titles determined to be similar.

3. The method of claim 2 wherein decomposing the set of representations of message thread contents into clusters of representations of message thread contents determined to be similar and decomposing the set of representations of message thread titles into clusters of representations of message thread titles determined to be similar comprises minimizing a function that includes a component that represents a probability that the representations of message thread titles are decomposed into clusters that are different from the clusters into which their corresponding representations of message thread contents are decomposed and that includes a component that represents entropies of the clusters of representations of message thread contents and the clusters of representations of message thread titles.

4. The method of claim 2 wherein:
decomposing the set of representations of message thread contents into clusters of representations of message thread contents determined to be similar comprises decomposing the set of representations of message thread contents into a first hierarchical tree of nodes of clusters of representations of message thread contents that each include a different cluster of representations of message threads contents such that the first hierarchical tree has a first root node that includes the set of representations of message thread contents and each child node in the first hierarchical tree includes a subset of the cluster of representations of message threads included in its parent node; and
decomposing the set of representations of message thread titles into clusters of representations of message thread titles determined to be similar comprises decomposing the set of representations of message thread titles into a second hierarchical tree of nodes of clusters of representations of message thread titles that each include a different cluster of representations of message thread titles such that the second hierarchical tree has a second root node that includes the set of representations of message thread titles and each child node in the second hierarchical tree includes a subset of the cluster of representations of message threads included in its parent node.

5. The method of claim 1 wherein:
constructing a set of representations of the contents of the accessed collection of message threads includes constructing, for each message thread within the collection of message threads, a feature vector representing the contents of the message thread; and
constructing a set of representations of the titles of the accessed collection of message threads includes constructing, for each message thread within the collection of message threads, a feature vector representing the title of the message thread.

6. The method of claim 1 wherein:
decomposing the set of representations of message thread contents into clusters of representations of message thread contents determined to be similar includes:
generating a first cluster of representations of message thread contents that includes multiple representations of message thread contents, and
generating a second cluster of representations of message thread contents that includes no more than one representation of message thread contents; and
decomposing the set of representations of message thread titles into clusters of representations of message thread titles determined to be similar includes:
generating a first cluster of representations of message thread titles that includes multiple representations of message thread titles, and
generating a second cluster of representations of message thread titles that includes no more than one representation of a message thread title.

7. The method of claim 1 further comprising:
receiving a search query;
comparing the received search query to representations of the clusters of representations of message thread titles;
based on comparing the received search query to the representations of the clusters of representations of message thread titles, identifying, from among the representations of the clusters of representations of message thread titles, a representation of a particular cluster of representations of message thread titles as matching the received search query; and
causing a display of indications of the message threads corresponding to the representations of message thread titles of the particular cluster.

8. A computer-implemented method comprising:
accessing, from a computer memory storage system, a collection of feature vectors that represent corresponding clusters of message threads, multiple of the feature vectors representing clusters of message threads that include more than one message thread;
receiving a search query;
comparing the received search query to the accessed collection of feature vectors;
based on comparing the received search query to the accessed collection of feature vectors, identifying, from among the collection of feature vectors, a particular feature vector as matching the received search query;
determining that the particular feature vector represents a particular cluster of one or more particular message threads; and
causing a display of indications of the one or more particular message threads.

9. The method of claim 8 further comprising:
after causing the display of the indications of the one or more particular message threads, receiving a request for more message threads;
accessing, from the computer memory storage system, a hierarchical tree having multiple nodes including a root node and multiple leaf nodes, each node in the tree including a different cluster of message threads and each parent node in the tree including all of the message threads from each of its child nodes, the clusters of message threads included in the leaf nodes corresponding to the clusters of message threads represented by the feature vectors in the collection of feature vectors;
as a consequence of having received the request for more message threads, identifying a particular parent node in the tree as being the parent node for a leaf node that, corresponds to the particular cluster of one or more message threads; and
causing a display of indications of the message threads included within the particular parent node.

10. The method of claim 8 wherein the feature vectors represent clusters of titles of message threads such that accessing a collection of feature vectors that represent corresponding clusters of message threads includes accessing a collection of feature vectors that represent corresponding clusters of titles of message threads.

11. The method of claim 8 wherein the feature vectors represent clusters of titles of message threads but not the content of the message threads such that accessing a collection of feature vectors that represent corresponding clusters of titles of message threads includes accessing a collection of feature vectors that represent corresponding clusters of titles of message threads but not the content of the message threads.

12. The method of claim 8 further comprising converting the received search query into a search query feature vector representing the received search query, wherein comparing the received search query to the accessed collection of feature vectors includes comparing the search query feature vector to the accessed collection of feature vectors.

13. The method of claim 8 wherein identifying, from among the collection of feature vectors, the particular feature vector as matching the received search query includes determining that, among the collection of feature vectors, the particular feature vector is most similar to the received search query.

14. A system comprising:
one or more processing elements; and
a computer memory storage system storing:
a set of representations of message thread titles,
a set of representations of message thread contents, each representation of message thread contents corresponding to a representation of a message thread title within the set of message thread titles, and
instructions that, when executed, cause the one or more processing elements to:
grow a hierarchical tree of clusters of the representations of message thread titles,
grow a hierarchical tree of clusters of the representations of message thread contents,
given the hierarchical tree of clusters of representations of message thread contents, prune the hierarchical tree of clusters of the representations of message thread titles to generate a pruned hierarchical tree of clusters of the representations of message thread titles having a reduced probability that the representations of message thread titles are included within clusters that are different from the clusters into which their corresponding representations of message thread contents are included relative to the un-pruned hierarchical tree of clusters of the representations of message thread titles, and
given the hierarchical tree of clusters of representations of message thread titles, prune the hierarchical tree of clusters of the representations of message thread contents to generate a pruned hierarchical tree of clusters of the representations of message thread contents having a reduced probability that the representations of message thread contents are included within clusters that are different from the clusters into which their corresponding representations of message thread titles are, included relative to the un-pruned hierarchical tree of clusters of the representations of message thread contents.

15. The system of claim 14 wherein:
the instructions that, when executed, cause the one or more processing elements to grow a hierarchical tree of clusters of the representations of message thread titles include instructions that, when executed, cause the one or more processing elements to use entropy of the hierarchical tree of clusters of the representations of message thread titles as a constraint on growth of the hierarchical tree of clusters of the representations of message thread titles; and
the instructions that, when executed, cause the one or more processing elements to grow a hierarchical tree of clusters of the representations of message thread contents include instructions that, when executed, cause the one or more processing elements to use entropy of the hierarchical tree of clusters of the representations of message thread contents as a constraint on growth of the hierarchical tree of clusters of the representations of message thread contents.
